(19) United States
(12) Patent Application Publication
(10) Pub. No.: US 2006/0266406 A1
(43) Pub. Date: Nov. 30, 2006

(54) Devulcanized photovoltaic roofing tiles

(76) Inventors: Tom Faust, Corte Madera, CA (US); Richard Haimann, Huntington Beach, CA (US)

Correspondence Address: Stephen E. Baldwin, 5310 Humboldt Drive, Rocklin, CA, 95765, US

(21) Appl. No.: 11/147,657

(22) Filed: Jun. 8, 2005

Related U.S. Application Data
(60) Provisional application No. 60/578,434, filed on Jun. 9, 2004.

(51) Int. Cl. H02N 6/00

(52) U.S. Cl. 136/244

(57) ABSTRACT

A design is presented for an integrated solar-voltaic roof tile that is durable, consistent in color with common roofing materials, and allows for installation of a roof system that produces cost-effective electricity from solar power. The design includes: 1. An elastomeric or polymeric substrate roof tile material. 2. An integrated solar-voltaic cell, which is molded into the roof tile, and appears as an integral part of the roof tile material. 3. A protective covering material composed of coated glass or a clear polymeric material that allows persons to walk on the roof without damaging the covering material, underlying solar-voltaic cell, or substrate material, and prevents water from entering the solar voltaic cell. 4. Electrical leads and plates built into the substrate material that connect to the solar-voltaic cell and, when roof tiles are installed in a traditional fashion, connect to each other so that the current from each solar voltaic cell flows through the roof system to a common electricity collector point, from which it is flows to a induction system that coverts direct current into alternating current and from which the current flows to the house electrical system or the public electricity grid.

### CROSS REFERENCE TO RELATED DOCUMENTS

The present Application is related to U.S. Pat. No. 6,579,482 for Process For Use Of Crumb Rubber In Moldable Formulations and U.S. Pat. No. 6,545,060 for Magnetostrictive Based Devulcanized Rubber.

The present application is also related to provisional patent application No. 60/578,434, filed Jun. 9, 2004 entitled “Devulcanized Photovoltaic Roofing Tiles”, the details of which are hereby incorporated by reference, and the benefit of the earlier Jun. 9, 2004 filing date is claimed in accordance with 35 USC 119 (e) (1).

### BACKGROUND OF THE INVENTION

Technology for the manufacturing of solar-voltaic cells has improved (cite relevant patents) to the point where application of the technology is becoming economically viable. The inventors have devised an integrated solar-voltaic roof tile that makes installation of home-based solar-voltaic electricity production economically viable and aesthetically acceptable. The environmental and social benefits of generating electricity from solar power are substantial. The application of this invention will allow for entire roof-based solar-voltaic electricity production systems to be installed cost-effectively with little change in the appearance of the roof system from that currently employed. The application of this invention will result in reducing dependency on fossil fuel sources for home energy needs.

We have developed a new color coordinated integrated photo voltaic roofing system that can significantly reduce the total cost of residential power generation by 75% and preferably deliver residential power at under 9¢ per kilowatt-hour (kWh).

North America generates about 300 million waste tires a year and over 10 million tons of rubber products are consumed each year. The majority of these tires and products are either burned as tire derived fuel (TDF) or buried. Less than 5% by volume are actually recycled, a significant decrease from the 1980's when at least 25% were recycled. The existing tire recycling processes contribute to global warming because a pound of elastomers when manufactured utilize over 60,000 BTU's. Without significant expansion of existing markets for waste tires, such as creating devulcanized photovoltaic roofing, the environmental threat they pose, will continue to grow.

A preferred method that has been proposed for devulcanization is ultrasound. See U.S. Pat. No. 6,545,060 Magnetostrictive based Devulcanized Rubber. Ultrasound inexpensively devulcanization breaks elastomeric chemical bonds such as CC, SS, SC, CSC, and CS.

Prior art in making Photovoltaic Cell Module Tile U.S. Pat. No. 6,489,662 using recessed photovoltaic cells fitted into a ceramic tile frame has not been significantly useful in industrial processes because of economic factors. This method does not offer a low cost system.

A common feature of all the prior art described above is that the processes taught have not been effective in increasing recycling. They are uneconomical, and provide power systems that are not architecturally attractive nor suitable for residential use. The prior art methods are incapable of assisting in the environmental effort to reduce global warming, save energy and reduce pollution such as by significantly increasing the recycling rate of elastomers.

### SUMMARY OF THE INVENTION

The present invention is an improved industrial power system and design for integrating photovoltaic cells with devulcanizing elastomers and other cross-linked polymers.

The process of the present invention creates an inexpensive devulcanized elastomeric material suitable for residential structural use that does not need chemical binders and is produced in commercial quantities.

### BRIEF DESCRIPTION OF THE DRAWINGS

FIG. 1 shows a rubberized body according to the present invention.

FIG. 2 a view of the solar cells incorporated into a roof.

FIG. 3 shows an embodiment of the present invention.

### DETAILED DESCRIPTION

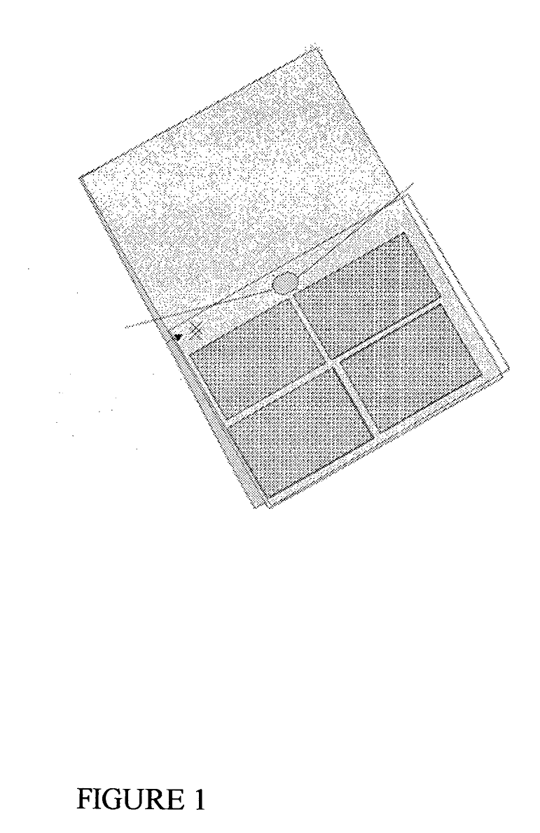

FIGS. 1 A rubberized body that contains at least 20% or more elastomeric and polymer materials that includes a photovoltaic cell module and a fitting section. The recess is provided in an indentation in the rubber cell module upon which the photovoltaic cell module complex is positioned. The module contains a glass cover to act as a pressure member to keep power-producing solar crystalline photovoltaic cells dry.

Dimensional slate or shingle shape formed in single, two or three tab shapes with 1 to 4 photo photovoltaic cells mounted on lower portion of each individual slate or shingle. The shingles or slates are covered with a high impact glass cover (auto windshield type) that is glued and fastened to the rubber or plastic base. The solar cells are connected by wires to form an electrical grid. The design is fully integrated into the existing roofing tiles so that it rests flat on the roof.

Integrated Residential roofing module systems will typically contain enough cells to generate 2.5 to 7 KW. The preferred rubberized material is made out of devulcanized tire rubber. However it may also be made out of combinations of SBR, EPDM, Hypalon, plastics and other polymer materials. It may be a Class “A” building materials described in U.S. Pat. Nos. 6,545,060 and 6,579,482.

Glass or clear polymeric cover clear or tinted covers lower half of rubberized slate/shingle is held firm by adhesive polymer similar to auto windshield is designed to be walked on. Can only be used on roofs with a 15%+ slope to prevent rainwater from entering.

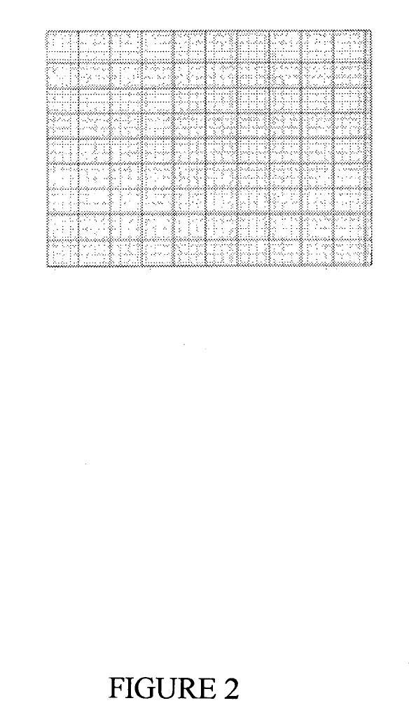

FIG. 2 is a view of the solar cells incorporated into a roof Integrated roof pattern where solar cell shingles and slates blend in with non solar cells shingles and slates. Typically a 3 kW integrated photo voltaic roof will have 25% integrated solar cells slates mixed with 75% non solar slate/shingles.

Integrated roofing color will be able to be matched using tinted glass and photo voltaic cells and laminated color layers containing color tinted HYPALON.®. (chlorosulfonated polyethylene elastomer) on the surface of the rubberized slab slate/shingle body.

Each tile may have interlocking tabs to facilitate placement of tile into grid pattern.

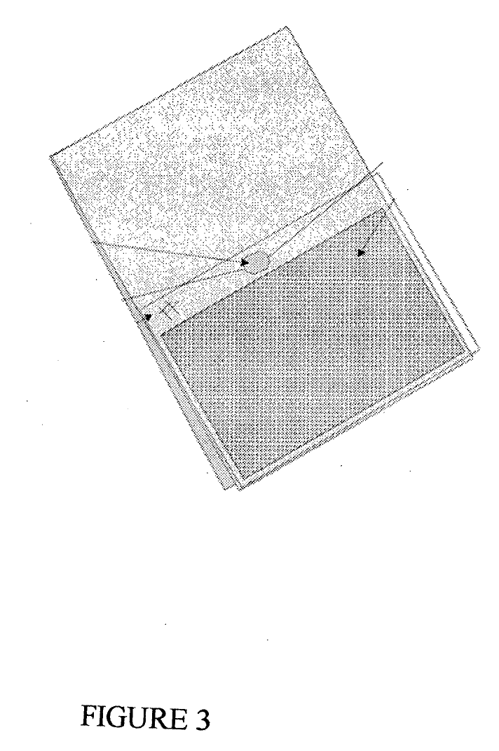

FIG. 3 is an embodiment of the present invention illustrating an improved solar cell that takes up the entire lower space on the slate/shingle. Glass cover covers lower half of rubberized slate/shingle is held firm by adhesive polymer similar to auto windshield is designed to be walked on. Can only be used on roofs with a 10%+ slope to prevent rainwater from entering photovoltaic area. Electrical connector & wires connect each molded shingle/slate to establish photovoltaic electrical grid.

### DETAILED DESCRIPTION OF THE PREFERRED EMBODIMENTS

Photovoltaic cells are known and commercially available, as are the parameters of operation of the DC to AC electrical grid and their methods of use. The problem with existing photovoltaic systems is the high cost of putting a system together. The purpose of this invention is to lower the cost by 75% or more to make it cost competitive with conventional power thereby increasing the use of residential photovoltaic systems.

The parameters and methods can vary widely in the practice of the present invention, although certain scalable ranges are preferred. A preferred range of photo voltaic power for residential use, for example, is from above 2 watts to 7 watts for the present invention, and is fully scalable by, for example, adding additional solar cells. The more efficient the photovoltaic cell is in generating electrical power the less photo voltaic cells are necessary.

Referring to FIGS. 1, 2 and 3, are embodiments of the roofing tiles used in an overlap system so that the adhesive and caulking used to mount the glass to the rubberized tile will always be covered from the sun.

They use a rubberized body that contains at least 20% or more elastomeric and polymeric materials that includes a photovoltaic cell module and a fitting section. The rubberized material was selected because it is a natural electrical insulator that facilitates the design and the construction of the system. The recess is provided in an indentation in the rubber cell module upon which the photovoltaic cell module complex is positioned. The module contains a glass cover to act as a pressure member to keep power-producing solar crystalline photovoltaic cells dry.

They are formed into a dimensional slate or shingle shape formed in single, two or three tab shapes with 1 to 10 photo photovoltaic cells mounted on lower portion of each individual slate or shingle. The shingles or slates are covered with a high impact glass cover (auto windshield type) that is glued and fastened to the rubber or plastic base. The solar cells are connected by wires to form an electrical grid. The design is fully integrated into the existing roofing tiles so that it rests flat on the roof.

Integrated Residential roofing module systems will typically contain enough cells to generate 2.5 to 7 KW. The preferred rubberized material is made out of devulcanized tire rubber. However it may also be laminated and made out of combinations of SBR, EPDM, Hypalon, plastics and other polymer materials. It may be a Class “A” building materials described in U.S. Pat. Nos. 6,545,060 and 6,579,482.

Glass or clear polymeric cover clear or tinted covers lower half of rubberized slate/shingle is held firm by adhesive polymer similar to auto windshield is designed to be walked on. Can only be used on roofs with a 15%+ slope to prevent rainwater from entering.

The design is integrated so the location of the solar cells is not readily apparent when Solar cells are incorporated into a roof Integrated roof pattern where solar cell shingles and slates blend in with non solar cells shingles and slates. Typically a 3 kW integrated photo voltaic roof will have 25% integrated solar cells slates mixed with 75% non solar slate/shingles.

Integrated roofing color will be able to be matched using tinted glass and photo voltaic cells and laminated color layers containing color tinted HYPALON.®. (chlorosulfonated polyethylene elastomer) on the surface of the rubberized slab slate/shingle body.

Each tile may have interlocking tabs to facilitate placement of tile into grid pattern.

The system is may have an improved solar cell that takes up the entire lower space on the slate/shingle. The economics of using just one large cell are apparent as there are less electrical connections. A glass cover covers lower half of rubberized slate/shingle is held firm by adhesive polymer similar to auto windshield is designed to be walked on. Can only be used on roofs with a 10%+ slope to prevent rainwater from entering photovoltaic area. Electrical connector & wires connect each molded shingle/slate to establish photovoltaic electrical grid.

The foregoing is offered primarily for purposes of illustration. Further modifications and substitutions that will be apparent to those skilled in the art can be made without departing from the spirit and scope of the invention as embodied in the claims.

What is claimed is:

1. A photovoltaic cell module tile comprising:
a. a design that integrates any combinations of elastomeric or polymeric materials including devulcanized elastomeric materials into high value molded shaped suitable for roofing including an integrated photovoltaic system;
b. a glass or teflon cover to keep the photovoltaic cells dry and protected from walking on or abrasion;
c. a polymeric glue and sealer that will bind the glass to the rubber;
d. aAn electrical grid system that connects any photovoltaic cells on the slate to a centralized electrical connector;
e. integrated design concept so that photovoltaic cell module molded shapes look similar to non photovoltaic tile molded shapes;
f. the shapes are molded so they interlock or connect with each other.

2. The photovoltaic cell module shingle slate according to claim 1 wherein a rigid integrated glass system that is similar to auto glass that is tinted or clear to match the polymeric materials (recycled tires or EPDM, SBR Hypalon) attached thereto.

3. In conjunction with claim 1, a system that uses chemical or ultrasonic welding to connect parts together on the molded roofing tile.

4. In conjunction with claim 1, a Class “A” fire retardant roofing system.
